(19) United States
(12) Patent Application Publication
(10) Pub. No.: US 2018/0335776 A1
(43) Pub. Date: Nov. 22, 2018

(54) SYSTEMS AND METHODS FOR SELECTING DRIVING MODES IN AUTONOMOUS VEHICLES

(71) Applicant: GM GLOBAL TECHNOLOGY OPERATIONS LLC, Detroit, MI (US)

(72) Inventors: NICHOLAS D. THEIS, ST. JOHN'S, MI (US); SCOTT W. DAMMAN, WHITE LAKE, MI (US); MICHAEL MCGUIRE, MILFORD, MI (US)

(73) Assignee: GM GLOBAL TECHNOLOGY OPERATIONS LLC, Detroit, MI (US)

(21) Appl. No.: 15/597,001

(22) Filed: May 16, 2017

(51) Int. Cl. G05D 1/00; B60W 30/02

(52) U.S. Cl. CPC G05D 1/0088; B60W 2540/04; B60W 30/025

(57) ABSTRACT

Systems and method are provided for controlling a vehicle. A method of determining a driving mode includes receiving occupant preference information, the occupant preference information including a set of predefined vehicle modes and, for each of the predefined vehicle modes, a set of occupant state criteria and a set of vehicle parameters. The method further includes receiving a set of occupant state parameters indicative of the state of one or more occupants of the vehicle, determining whether the occupant state parameters satisfy first occupant state criteria associated with a first vehicle mode of the set of predefined vehicle modes, and engaging the vehicle tuning parameters associated with the first vehicle mode if the occupant state parameters satisfy the first occupant state criteria.

### TECHNICAL FIELD

The present disclosure generally relates to autonomous vehicles, and more particularly relates to systems and methods for selecting driving modes in an autonomous vehicle.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While recent years have seen significant advancements in autonomous vehicles, such vehicles might still be improved in a number of respects. For example, currently-known autonomous vehicles often offer only one or two driving modes, while the nature of autonomous vehicles is such that a wide range of driving modes may be appropriate under various circumstances, depending upon the preferences of the its occupants. Stated another way, autonomous vehicles by their very nature should allow for new modes of occupant interaction with the vehicle and new ways for engagement within the vehicle.

Accordingly, it is desirable to provide systems and methods for selecting driving modes in autonomous vehicles. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling an autonomous vehicle. In one embodiment, a method of determining a driving mode includes receiving occupant preference information, the occupant preference information including a set of predefined vehicle modes and, for each of the predefined vehicle modes, a set of occupant state criteria and a set of vehicle parameters. The method further includes receiving a set of occupant state parameters indicative of the state of one or more occupants of the vehicle, determining whether the occupant state parameters satisfy first occupant state criteria associated with a first vehicle mode of the set of predefined vehicle modes, and engaging the vehicle tuning parameters associated with the first vehicle mode if the occupant state parameters satisfy the first occupant state criteria.

In one embodiment, an autonomous vehicle includes one or more sensors provided within an interior of the autonomous vehicle, the one or more sensors configured to observe an occupant within the interior of the autonomous vehicle and produce sensor data associated therewith, and a vehicle mode determination module, including a processor. The vehicle mode determination module is configured to: receive occupant preference information, the occupant preference information including a set of predefined vehicle modes and, for each of the predefined vehicle modes, a set of occupant state criteria and a set of vehicle parameters; receive a set of occupant state parameters indicative of the state of one or more occupants of the vehicle; determine whether the occupant state parameters satisfy first occupant state criteria associated with a first vehicle mode of the set of predefined vehicle modes; and engage the vehicle tuning parameters associated with the first vehicle mode if the occupant state parameters satisfy the first occupant state criteria..

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a driving mode selection system, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a dataflow diagram illustrating a vehicle mode determination system of an autonomous vehicle, in accordance with various embodiments; and

FIG. 5 is a conceptual interior view of an autonomous vehicle in accordance with various embodiments; and

FIGS. 6 and 7 are flowcharts illustrating a control method for controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

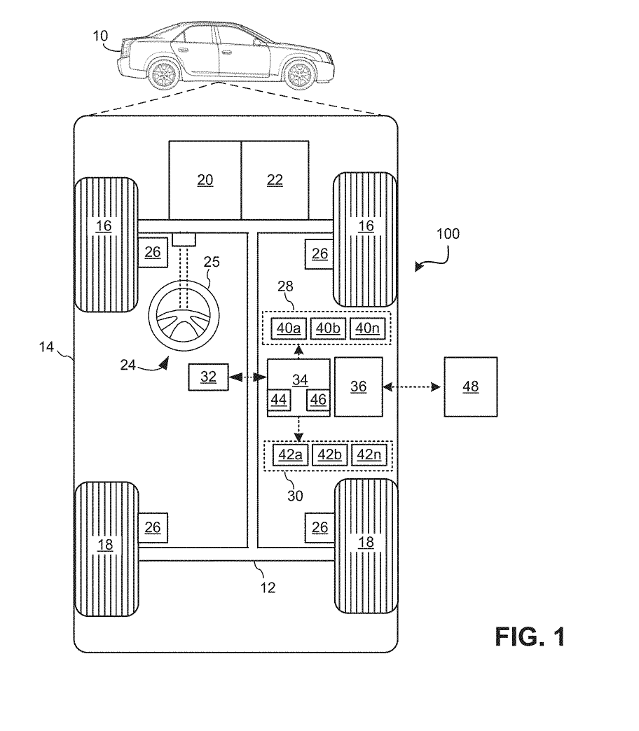

With reference to FIG. 1, a vehicle mode selection system shown generally as 100 is associated with a vehicle 10 in accordance with various embodiments. In general, vehicle mode selection system (or simply “system”) 100 allows for a variety of operation modes based on, among other things, occupant preferences and parameters indicative of the state of the occupant(s) of the autonomous vehicle. In one embodiment, for example, a “sleep mode” is provided by the vehicle in cases where the occupant preferences authorize such a mode and the state of the occupant or occupants is consistent with those associated with a sleep mode.

As depicted in FIG. 1, vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the driving mode selection system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, driving mode selection systems in accordance with the present embodiment may be used in conjunction with any autonomous vehicle that utilizes a navigation system to provide route guidance.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n might include, but are not limited to, radars, lidars, global positioning systems, optical cameras, thermal cameras, ultrasonic sensors, and/or other sensors. In some embodiments, sensing devices 40a-40n include one or more sensors capable of observing occupants of the vehicle and classifying their respective states (e.g., using a trained neural network or other such classification model known in the art).

The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

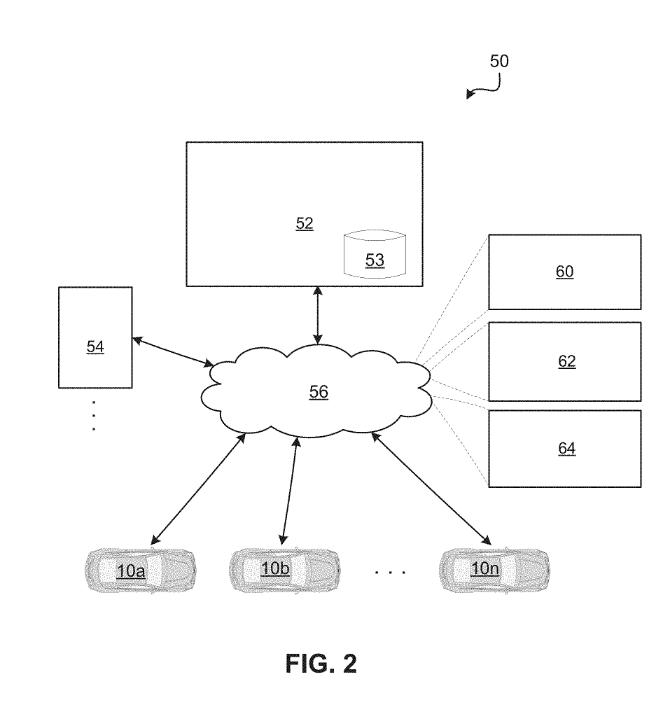

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10. In one embodiment, as discussed in detail below, controller 34 is configured to allow an occupant to select a driving mode based on occupant preferences, vehicle state, and occupant state.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n . This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

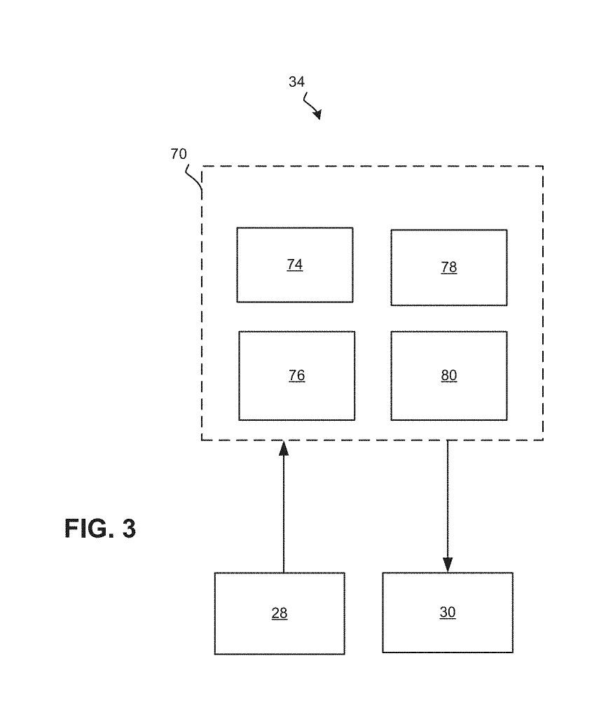

In accordance with various embodiments, controller 34 implements an autonomous driving system (ADS) 70 as shown in FIG. 3. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, the driving mode determination system 100 of FIG. 1 is configured to allow an occupant to adjust, with a high degree of customization and granularity, the driving parameters of AV 10 based on one or more predefined vehicle modes (e.g., sleep mode, eco-mode, luxury mode, high-performance mode, or the like).

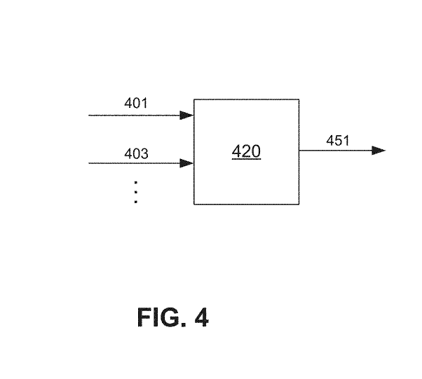

Referring now to FIG. 4, an exemplary vehicle mode determination system 400 generally includes a vehicle mode determination module (or simply “module”) 420 that receives occupant preference information 401, and parameters indicative of occupant state (or “occupant state parameters”) 403. Module 420 then produces an output 431 corresponding to an appropriate vehicle mode—e.g., a set of parameter adjustments associated with one or more vehicle operational modes.

The phrase “vehicle mode” or “vehicle operational mode” as used herein generally refers to the behavior of autonomous vehicle 10 as determined by the vehicle parameters that are operative at a particular point in time. Without limitation, such vehicle parameters might include, for example, transmission shift points, maximum acceleration/deceleration rates, torque converter clutch slip, exhaust noise, road noise, engine mount rates, active noise cancellation, suspension softness, engine calibration adjustments, seat position and characteristics, cylinder deactivation, route selection, interior lighting, media volume, and the like.

In one embodiment, autonomous vehicle 10 by default includes a set of vehicle modes, but also allows a user to create and customize, with a high degree of detail, new vehicle modes. For example, in one embodiment an autonomous vehicle 10 might offer the following modes: vehicle-determined mode (in which autonomous vehicle 10 determines the optimal vehicle mode under present conditions), sleep mode (in which one or more of the occupants are determined, via appropriate sensors, to be asleep or resting), custom mode (in which a user has defined a set of arbitrary vehicle parameters), eco-mode (in which the vehicle parameters are optimized for reduced energy usage), luxury mode (in which, for example, the vehicle parameters are optimized for a soft, quiet ride), and high-performance mode (in which vehicle parameters are optimized for “sporty” operation).

Occupant preference information 401 includes, in any form, the set of all possible vehicle modes combined with the vehicle parameters and settings used to engage each particular vehicle mode. Such preferences (which may be stored as any convenient data structure) may be produced in response to a prompt to the occupant(s), or may be the result of a predefined preferences entered by an occupant or other user via an appropriate user interface. In one embodiment, for example, the user interface is supplied by an application that runs on a mobile device, such as a smartphone configured to communicate with autonomous vehicle 10. In some embodiments, the preferences 401 are stored within a portable memory device and are transferred to vehicle 10 through a suitable interface (e.g., a USB interface) prior to operation of vehicle 10. In some embodiments, the user interface may include a table, driver interface controls, an infotainment screen in vehicle 10, or a spoken word interface.

Occupant state parameters 403 include information characterizing the state of one or more occupants of AV 10 (as determined via sensors 511, 512). For example, parameters 403 might indicate whether there are occupants in a third row of a vehicle (in which case sport driving might be undesirable), the age of the occupants, the driving experience of the occupants, whether one or more occupants are sleeping or otherwise not as alert as may be desired, and the like.

While not illustrated in FIG. 4, module 420 may also consider various vehicle state parameters in making a determination as to the appropriate vehicle mode. Such parameters might include information relating to the vehicle and its environment, such as local traffic density, the nature of the current roadway, local weather conditions, coefficient of friction of the roadway, and the like.

Module 420 may be implemented in a variety of ways, ranging from a relatively simple decision tree to a machine learning model that undergoes either supervised or unsupervised learning. In general, it will be understood that various embodiments of the system 100 according to the present disclosure can include any number of sub-modules embedded within the controller 34. As can be appreciated, the sub-modules shown in FIG. 4 can be combined and/or further partitioned to similarly select driving modes. Inputs to the system 100 may be received from the sensor system 28, received from other control modules (not shown) associated with the autonomous vehicle 10, received from the communication system 36, and/or determined/modeled by other sub-modules (not shown) within the controller 34 of FIG. 1.

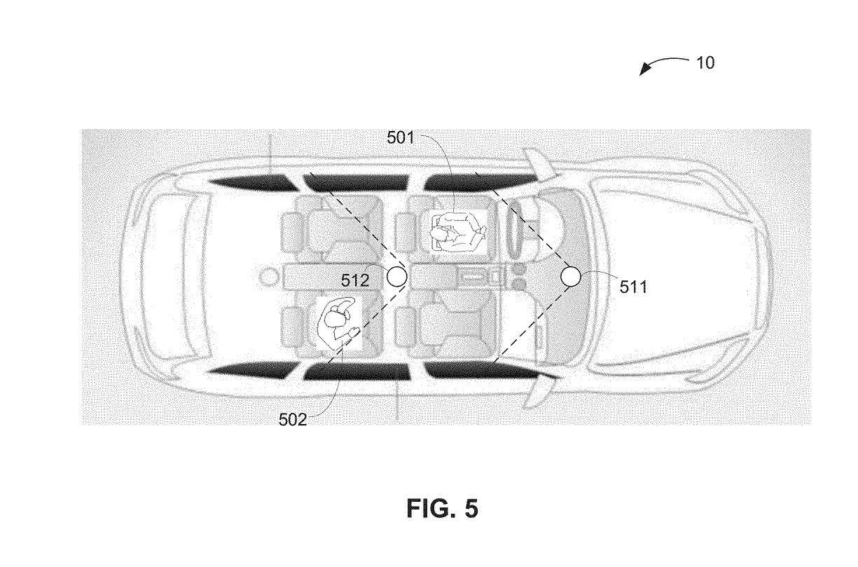

FIG. 5 depicts, in simplified form, the interior of an exemplary vehicle 10 including two occupants: occupant 501, shown seated in the front driver's seat, and occupant 502, shown seated in a rear passenger seat. Also shown in FIG. 5 are two sensors 511 and 512 that are configured to observed occupants 501 and 502, as well as any other occupants that may reside in vehicle 10. It will be understood that any number of sensors may be employed in any convenient locations, and that the illustrated embodiment is not intended to be limiting. Regardless of the number and location of sensors 511, 512, the sensors may be IR sensors, optical sensors, or any other kind of sensor that is capable of producing an image or the like indicative of the state of occupants 501 and 502. The data produced by sensors 511 and 512 is thus used as input 403 to module 420, as shown in FIG. 4.

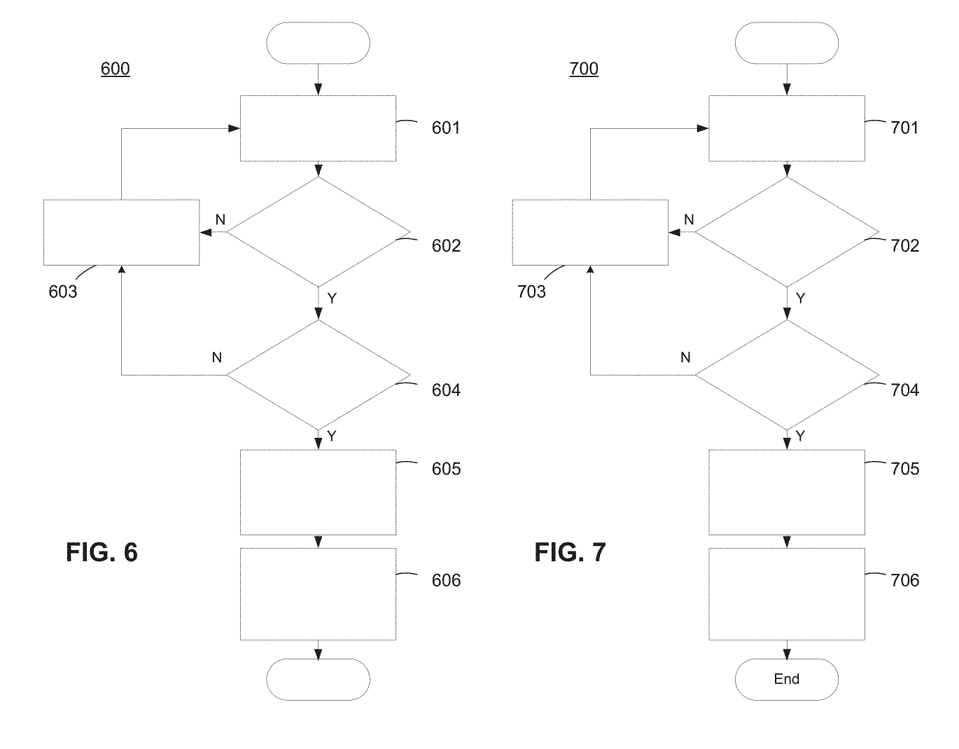

Referring now to FIGS. 6 and 7, and with continued reference to FIGS. 1-5, the illustrated flowcharts provide control methods 600 and 700 that can be performed by system 100 in accordance with the present disclosure. As can be appreciated in light of the disclosure, the order of operation within the method is not limited to the sequential execution as illustrated in FIGS. 6 and 7, but may be performed in one or more varying orders as applicable and in accordance with the present disclosure. In various embodiments, the methods 600 and 700 can be scheduled to run based on one or more predetermined events, and/or can run continuously during operation of the autonomous vehicle 10.

FIG. 6 presents a generalized flow-chart illustrating how a vehicle mode may be selected, and FIG. 7 presents a specific embodiment associated with selection of a “sleep” mode (i.e., a mode appropriate for the scenario in which one or more occupants appear to be asleep). Thus, steps 701-706 in FIG. 7 correspond, in general, to steps 601-606 in FIG. 8, with the exceptions noted below.

Referring to FIG. 6, the process begins at 601, in which the system (e.g., sensors 501 and 502 in conjunction with suitable hardware and software within controller 34) monitors the state of the various occupants (e.g., 501 and 502) within vehicle 10. Suitable machine learning methods, such as convolutional neural networks (CNNs) may be used for this task. As mentioned above, the monitoring of occupants is used to generate information regarding the seating arrangement of occupants in the vehicle, the weight/size of the occupants, whether one or more occupants are sleeping or otherwise not concentrating on the roadway, and the like. In some embodiments, the facial expression of the occupants is used to determine an apparent mood of the occupants. In other embodiments, child-restraint seats and other such objects may be detected within the interior.

Attributes associated with an occupant's state of awareness might also include where the occupant is looking, the extent to which the occupant's eyes are closed, how often and for how long they are shutting their eyes, their body posture, notable head movements such as a “head nod”, whether the occupant has been yawning, occupant seating position, visual indicators of sleep deprivation, such as prominence of eye veins, and the like.

In another embodiment, one mode of operation corresponds to a “car sickness risk mitigation profile” or “car sickness avoidance mode” for high risk passengers mode. In this mode, the system would adjust driving vehicle state to decrease the risk of the occupant getting sick within the vehicle. Some occupants, such as heavily impaired occupants, may be at much greater risk for vehicle sickness. This could be costly for ride-sharing companies in cases where an occupant does actually get sick within a vehicle. Accordingly, the system might look at parameters such as body movements, occupant voice analysis (slurred speech), pupil dilation, the content of the occupants speech (“I′m getting car sick”, “I feel like I′m going to throw up”, etc.), body temperature data, or the like. Parameters that might be adjusted include vehicle acceleration and deceleration rates, suspension rate changes (softer ride), engine calibration, cylinder deactivation, etc. The system might also adjust route path to drive on a route that is easier on the passenger from a car sickness standpoint (e.g., favoring smooth highways).

Next, at 602, the system determines whether the state of the occupant or occupants satisfy the occupant state criteria of a predefined vehicle mode—e.g., a predefined state stored within controller 43 and including, for each enumerated vehicle mode, the criteria associated with that mode along with the vehicle parameters to be adjusted to engage that mode. /*

If it is determined that the occupant state(s) satisfy predefined occupant criteria for a driving mode, processing continues to 604; otherwise, the system continues with the current driving mode (603) then returns to 601 and continues to monitor occupant states.

At 604, the system determines whether the predefined vehicle mode has been enabled. This might correspond, for example, to a user-configurable binary flag stored along with the predefined vehicle modes and parameter values. If the predefined vehicle mode has not been enabled, then the system continues with the current driving mode (603) then returns to 601 and continues to monitor occupant states.

In some embodiments, the system determines whether a specific occupant is seated within vehicle 10 (e.g., through face recognition or other method), and then enables driving modes created by or for that specific occupant. Such occupant-specific preferences may also be dependent upon the location of that occupant. For example, a particular individual may prefer that sleep mode is enabled only when that individual is not seated in the driver's seat.

In some embodiments, the enablement of driving modes may be dependent on the apparent age and/or size of the occupants. That is, a “performance mode” may only be enabled in cases where the occupants do not include small children.

Next, at 605, the system determines (e.g., extracts from a set of values stored in controller 34) the vehicle parameters associated with the predefined driving mode, then engages those vehicle parameters to implement the selected driving mode.

FIG. 7 depicts, by way of illustration, an example in which a “sleep” mode is implemented. Specifically, steps 701-706 correspond, generally, to steps 601-606 in FIG. 6, except that 702 is specifically determines whether one or more of the occupants are in a “sleep state,” 704 determines if that a “sleep mode” has been enabled, and 705 determines the vehicle parameters associated with the sleep mode. In one embodiment, for example, the vehicle parameters associated with a sleep mode include: increasing torque converter clutch slip, reducing exhaust noise, increasing active noise cancellation, increasing seat softness and otherwise adjusting the seat configuration (for the sleeping occupant(s)), selecting less aggressive transmission shift points, dimming interior lighting, reducing the maximum acceleration rate, choosing a route with fewer stops and corners, choosing a route with more amenable weather conditions, choosing a route with minimal road roughness, reducing engine noise, and reducing the stiffness of the suspension.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of determining a driving mode for an autonomous vehicle, the method comprising:
receiving occupant preference information, the occupant preference information including a set of predefined vehicle modes and, for each of the predefined vehicle modes, a set of occupant state criteria and a set of vehicle parameters;
receiving a set of occupant state parameters indicative of the state of one or more occupants of the vehicle;
determining whether the occupant state parameters satisfy first occupant state criteria associated with a first vehicle mode of the set of predefined vehicle modes; and
engaging the vehicle parameters associated with the first vehicle mode if the occupant state parameters satisfy the first occupant state criteria.

2. The method of claim 1, wherein the vehicle parameters include parameters relating to at least one of transmission shift points, maximum acceleration rate, torque converter clutch slip, exhaust noise, road noise, engine mount rates, active noise cancellation, suspension rates, engine calibration, seat characteristics, cylinder deactivation, seat position, and route selection.

3. The method of claim 1, wherein the set of predetermined vehicle modes includes a sleep mode, and the set of occupant state parameters includes a determination as to whether one or more of the occupants appear to be asleep.

4. The method of claim 1, wherein the set of predefined vehicle modes includes a sleep mode, an economy mode, a luxury mode, a user-customized mode, and a high performance mode.

5. The method of claim 1, wherein the set of predefined vehicle modes includes a car-sickness avoidance mode.

6. The method of claim 1, wherein the set of occupant state parameters are determined in part from a set of optical sensors provided within an interior of the vehicle.

7. The method of claim 1, further including seeking from the one or more occupants of the vehicle a confirmation that the first vehicle mode should be engaged.

8. An autonomous vehicle comprising:
one or more sensors provided within an interior of the autonomous vehicle, the one or more sensors configured to observe an occupant within the interior of the autonomous vehicle and produce sensor data associated therewith;
a vehicle mode determination module, including a processor, configured to:
receive occupant preference information, the occupant preference information including a set of predefined vehicle modes and, for each of the predefined vehicle modes, a set of occupant state criteria and a set of vehicle parameters;
receive a set of occupant state parameters indicative of the state of one or more occupants of the vehicle;
determine whether the occupant state parameters satisfy first occupant state criteria associated with a first vehicle mode of the set of predefined vehicle modes; and
engage the vehicle parameters associated with the first vehicle mode if the occupant state parameters satisfy the first occupant state criteria.

9. The autonomous vehicle of claim 8, wherein the vehicle parameters include parameters relating to at least one of transmission shift points, maximum acceleration rate, torque converter clutch slip, exhaust noise, road noise, engine mount rates, active noise cancellation, suspension rates, engine calibration, seat characteristics, cylinder deactivation, seat position, and route selection.

10. The autonomous vehicle of claim 8, wherein the set of predetermined vehicle modes includes a sleep mode, and the set of occupant state parameters includes a determination as to whether one or more of the occupants appear to be asleep.

12. The autonomous vehicle of claim 8, wherein the set of predefined vehicle modes includes a sleep mode, an economy mode, a luxury mode, a user-customized mode, and a high performance mode.

13. The autonomous vehicle of claim 8, wherein the set of predefined vehicle modes includes a car-sickness avoidance mode.

14. The autonomous vehicle of claim 8, wherein the set of occupant state parameters are determined in part from a set of optical sensors provided within an interior of the vehicle.

15. The autonomous vehicle of claim 8, wherein the vehicle mode determination module further seeks from the one or more occupants of the vehicle a confirmation that the first vehicle mode should be engaged.

16. An system for controlling an autonomous vehicle, the system comprising:
one or more sensors provided within an interior of the autonomous vehicle, the one or more sensors configured to observe an occupant within the interior of the autonomous vehicle and produce sensor data associated therewith;
a vehicle mode determination module, including a processor, configured to:
receive occupant preference information, the occupant preference information including a set of predefined vehicle modes and, for each of the predefined vehicle modes, a set of occupant state criteria and a set of vehicle parameters;
receive a set of occupant state parameters indicative of the state of one or more occupants of the vehicle;
determine whether the occupant state parameters satisfy first occupant state criteria associated with a first vehicle mode of the set of predefined vehicle modes; and
engage the vehicle parameters associated with the first vehicle mode if the occupant state parameters satisfy the first occupant state criteria.

17. The system of claim 16, wherein the vehicle parameters include parameters relating to at least one of transmission shift points, maximum acceleration rate, torque converter clutch slip, exhaust noise, road noise, engine mount rates, active noise cancellation, suspension rates, engine calibration, seat characteristics, cylinder deactivation, seat position, and route selection.

18. The system of claim 16, wherein the set of predetermined vehicle modes includes a sleep mode, and the set of occupant state parameters includes a determination as to whether one or more of the occupants appear to be asleep.

19. The system of claim 16, wherein the set of predefined vehicle modes includes a sleep mode, an economy mode, a luxury mode, a user-customized mode, and a high performance mode.

20. The system of claim 16, wherein the set of occupant state parameters are determined in part from a set of optical sensors provided within an interior of the vehicle.
